(19) United States
(12) Patent Application Publication
(10) Pub. No.: US 2002/0045382 A1
(43) Pub. Date: Apr. 18, 2002

(54) Flat cable-connecting connector

(75) Inventor: Toshiharu Takahashi, Shizuoka (JP)

Correspondence Address: SUGHRUE, MION, ZINN, MACPEAK & SEAS, PLLC, 2100 Pennsylvania Avenue, N.W., Washington, DC, 20037, US

(73) Assignee: YAZAKI CORPORATION

(21) Appl. No.: 09/977,969

(22) Filed: Oct. 17, 2001

(30) Foreign Application Priority Data
Oct. 17, 2000 (JP) P. 2000-316572

(51) Int. Cl. H01R 12/24

(52) U.S. Cl. 439/499

(57) ABSTRACT

A portion (21a) of each electric wire of a flat cable (20), defining a bottom portion of a bent portion thereof, is electrically press-connected to a press-connecting blade (13a) of a male terminal (13). Portions (21b, 21c) of the electric wire, disposed respectively at the front and rear sides of the electrically-connected portion of the electric wire, ride on wire holding ribs (14a, 14b), respectively. The ridden portions (21b, 21c) of the electric wire are pressed and held by a wire holding cover (16). The ridden portions (21b, 21c) of the electric wire bear the burden of a tension or a stress due to a pulling force applied to the flat cable, and therefore the tension will not act on the electrically-connected portion of the electric wire, press-connected to the press-connecting blade (13a).

### BACKGROUND OF THE INVENTION

1. Field of the Invention

The present invention relates to a connecting connector for holding a flat cable (comprising a plurality of juxtaposed insulated electric wires joined together into an integral, flattened form) or a ribbon cable in electrically-connected relation thereto.

The present application is based on Japanese Patent Application No. 2000-316572, which is incorporated herein by reference.

2. Description of the Related Art

Generally, an electric connector of the type, which is called “a press-connecting connector”, comprises a female connector and a male connector which are designed to be fitted together, and female terminals, held in the female connector, are press-connected respectively to male terminals, held in the male connector, thereby making electrical connection therebetween. In this case, a flat cable is introduced, for example, into the male connector, and is press-connected to the male terminals, and in this condition the male terminals are press-connected to the female terminals, respectively, thereby electrically connecting the three associated elements (that is, each electric wire and the corresponding female terminal and the corresponding male terminal) together.

There are occasions when a tension or a stress due to an accidental pulling force or the like acts on the three elements (electric wire/female terminal/male terminal)-interconnected portion through the flat cable. Therefore, it is necessary to firmly hold the flat cable so that each electric wire of the flat cable will not be displaced or disengaged from a press-connecting portion of the male/female terminal even in such a case.

FIGS. 4A and 4B show a flat cable connector disclosed in Unexamined Japanese Utility Model Publication No. Sho. 55-87682. The flat cable connector is provided with a protective structure for preventing the disengagement of electric wires upon application of such an external pulling force. These Figures show only a male connector. More specifically, the male connector 1 includes a terminal block 2 holding a plurality of male terminals 3 therein (which are inserted into this terminal block, for example, by press-fitting), and a wire holding block 4, called a tension-proof member, is connected to this terminal block 2 by a convex-concave fitting structure.

A flat cable 5 is formed by joining a plurality of juxtaposed electric wires 6 together into an integral, flattened form, by fusion or other means, and first, a connection end portion of this flat cable is introduced into the wire holding block 4. Then, when the wire holding block 4, holding the connection end portion of the flat cable 5, is fittingly connected to the terminal block 2 in an integrated manner, the electric wires 6 of the cable are held or clamped between the wire holding cover 4 and the terminal block 2. The male terminals 3 are brought into biting engagement with the electric wires 6, respectively, by a press-connecting force produced in this clamping operation. Each male terminal 3 has a press-connecting blade, and this press-connecting blade cuts an insulating sheath of the electric wire 6, so that the male terminal 3 comes into contact with a wire conductor within the electric wire, thereby achieving electrical connection between the electric wire and the male terminal.

In the male connector 1 thus assembled, the connection end portion 5a of the flat cable 5 is held between the terminal block 2 and the wire holding block 4 under pressure in such a manner that this connection end portion 5a is rounded to be loosened. Therefore, even when a tension due to an external pulling force or the like acts on the flat cable 5, the cable-loosened portion absorbs this tension, thereby preventing the tension from acting directly on the connected portion of the conductor of each electric wire 6 connected to the male terminal 3. This protection eliminates a disadvantage that the connected portion of each electric wire is displaced out of position, and is, in some cases, completely disengaged from the terminal, which results in the cutting of the electric wire.

In the meantime, the conventional structure, shown in FIGS. 4A and 4B has the following problems.

As shown in the drawings, the connection end portion 5a of the flat cable 5 is introduced into the male connector 1 in such a manner that the tension absorbing portion is formed by the loosened portion of this connection end portion 5a. In this case, the connection end portion 5a of one flat cable 5 is fastened to one male connector 1, and therefore the intended purpose can be achieved without any problem.

However, when one flat cable 5 is to be connected to one male terminal 1 intermediate the opposite ends of the flat cable 5, the structure, shown in FIGS. 4A and 4B, can not meet with this arrangement. There have been proposed other structures in which such an intermediate portion of the flat cable 5 is connected to the male connector. In this case, however, it is necessary to completely turn the intermediate portion of the cable into a U-shape. When the male connector, shown in FIGS. 4A and 4B, is designed to hold this U-turn portion of the cable, particularly the structure of the wire holding block 4 with the tension-proof function becomes complicated. As a result, there are encountered problems that the cost increases and that the cable-attaching operation is cumbersome, and is not efficient.

### SUMMARY OF THE INVENTION

With the above problems in view, it is an object of the present invention to provide a press-connecting connector for press-holding a flat cable in electrically-connected relation thereto, in which even an intermediate portion of the flat cable can be electrically connected to the connector with a simple structure and a simple assembling operation.

According to a first aspect of the present invention, there is provided a flat cable-connecting connector which comprises a terminal block to which a plurality of male terminals having press-connecting blades are attachable; a plurality of wire holding ribs formed on the terminal block in a projected manner, the wire holding ribs being respectively located at front and rear sides of the press-connecting blades of the male terminals held by the terminal block; and a wire holding cover attachable to the terminal block in order to hold a flat cable including a plurality of electric wires between the wire holding cover and the terminal block, wherein when the wire holding cover is attached to the terminal block, the flat cable is bent between the wire holding ribs, so that the flat cable is press-connected, at a predetermined portion of the flat cable in a direction of a length thereof, to the press-connecting blades of the male terminals held by the terminal block.

In this construction, an intermediate portion (i.e., target portion) of the flat cable is pressed by the wire holding cover from the upper side, and is pressed into the space between the wire holding ribs on the terminal block, so that this intermediate portion of the cable is held between the wire holding cover and the terminal block. The portion of each electric wire of the thus pressed flat cable, defining a bottom portion of the bent portion thereof, is electrically press-connected to the press-connecting blade of the male terminal. The portions of the electric wire, disposed respectively at the front and rear side of this electrically-connected portion of the electric wire, ride on the wire holding ribs, respectively. The portions of the electric wire, riding respectively on the wire holding ribs, are pressed and held by the wire holding cover. Therefore, even when a tension or a stress due to a pulling force is applied to the flat cable, the ridden portions of the electric wire bear the burden of this tension, and therefore the tension will not act on the electrically-connected portion of the electric wire, press-connected to the press-connecting blade of the male terminal, thus protecting this connected portion.

According to a second aspect of the present invention, it is preferable that a pair of the wire holding ribs are located at the front and rear sides of the press-connecting blades of the male terminals, and are disposed in parallel relation to each other, wherein when the wire holding cover is attached to the terminal block, first portions of the flat cable respectively located at front and rear sides of a second portion thereof, that is press-connected to the press-connecting blades, ride respectively on the pair of wire holding ribs, so that the first portions are pressed and held by the wire holding cover.

In accordance with the second aspect of the present invention, the pair of parallel, elongate wire holding ribs are provided respectively at the front and rear sides of the press-connecting blades of the male terminals held by the terminal block, and the portions of each electric wire, disposed respectively at the front and rear sides of the electrically-connected portion of the electric wire of the flat cable, ride on the two wire holding ribs, respectively. Therefore, even when a tension is applied to the flat cable from either side of the connector, the ridden portions of the electric wire bear the burden of the tension, thereby protecting the electrically-connected portion of the electric wire press-connected to the press-connecting blade.

According to a third aspect of the present invention, it is preferable that a groove portion of a recessed cross-section is formed between the pair of parallel wire holding ribs, and a convex portion is formed on an inner surface of the wire holding cover, wherein the convex portion is engaged in the groove portion to press-hold the flat cable.

In accordance with the third aspect of the present invention, the flat cable is held and clamped in such a manner that the flat cable is bent into a generally U-shape or a flanged cap-shape over the area of engagement therebetween. Accordingly, the tension hardly acts on the electrically-connected portion of the electric wire press-connected to the press-connecting blade of the male terminal, and therefore the electrically-connected portion of the electric wire will not be displaced from the male terminal, and will not be disengaged therefrom, thus preventing the cutting of the electric wire.

### BRIEF DESCRIPTION OF THE DRAWINGS

FIG. 1 is a perspective view of a male connector of a preferred embodiment of a flat cable-connecting connector of the present invention in its assembled condition;

FIG. 2 is a perspective view of the male connector in its disassembled condition;

FIG. 3 is a transverse cross-sectional view of the male connector in the assembled condition, to which a cable is electrically connected; and

FIGS. 4A and 4B are a perspective view and a transverse cross-sectional view of a male connector of a conventional flat cable-connecting connector in its assembled condition, respectively.

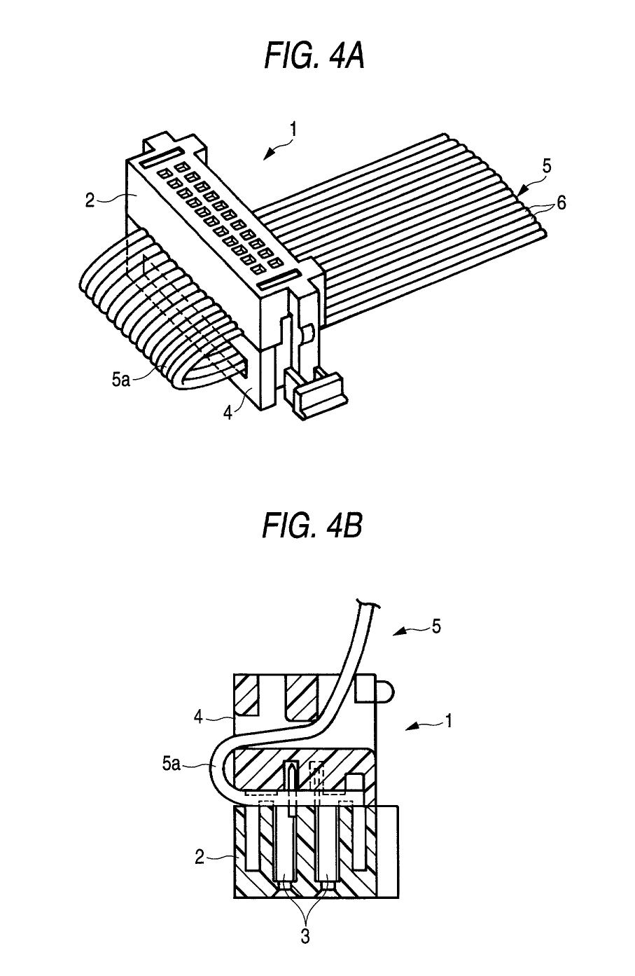

### DETAILED DESCRIPTION OF THE PREFERRED EMBODIMENT

A preferred embodiment of a flat cable-connecting connector of the present invention now will be described in detail with reference to the drawings.

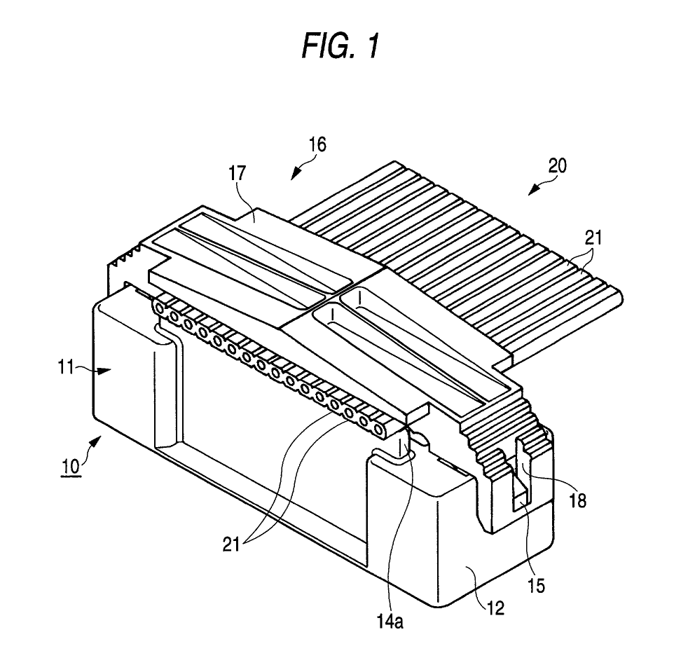

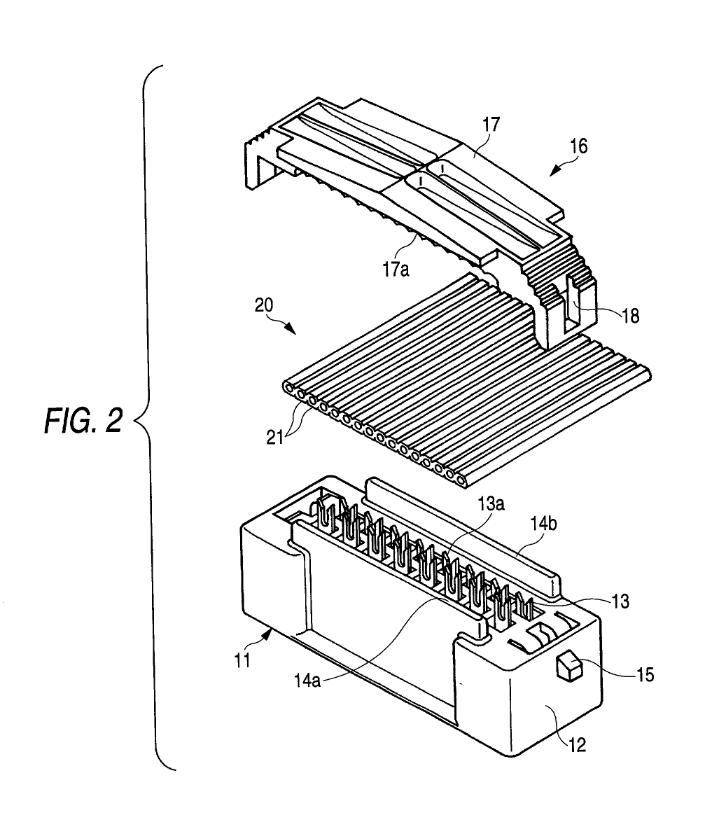

FIG. 1 is a perspective view showing a male connector 10 (which forms, together with a female connector, the press-connecting connector of this embodiment), in an assembled condition, and FIG. 2 is a perspective view of the male connector 10 in a disassembled condition. The press-connecting connector is assembled by fitting the female connector (not shown) on the male connector 10.

The male connector 10 comprises a resin-molded terminal block 11 (serving as a connector body) holding male terminals 13 press-fitted therein, and a resin-molded wire holding cover 16 connected to the terminal block 11 in a fitting manner, each of the male terminals 13 having a press-connecting blade 13a.

As shown in FIG. 2, the terminal block 11 includes an elongate box-like housing 12, and the plurality of male terminals 13 are held in this housing by press-fitting, and are arranged, for example, in two rows in a longitudinal direction thereof. The press-connecting blade 13a is formed on that portion of each male terminal 13 projecting from an upper surface of the housing. A pair of parallel wire holding ribs 14a and 14b are formed integrally at front and rear sides of the housing 12, respectively, and project from the upper surface of this housing. The rows of male terminals 13 are arranged between the pair of parallel front and rear wire holding ribs 14a and 14b. Fitting projections 15, used when fittingly connecting the wire holding cover 16 to the terminal block, are formed on opposite end surfaces of the housing 12, respectively.

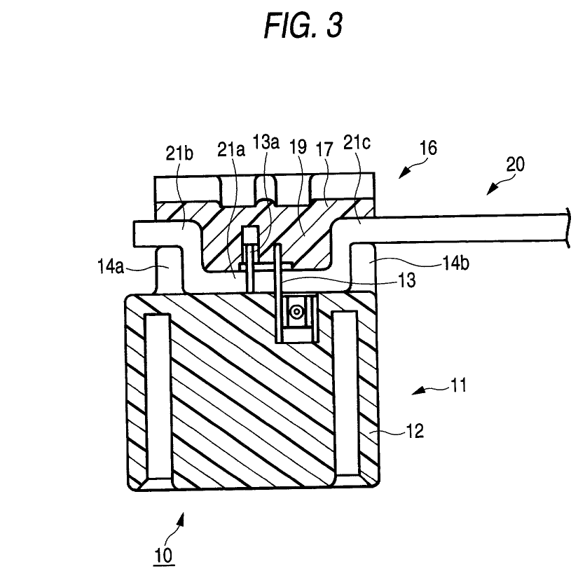

The wire holding cover 16 has a length generally equal to the length of the terminal block 11, and has an elongate shape so as to fit in the terminal block 11 to cover the upper side of this terminal block. As shown in FIG. 3 which is a transverse cross-sectional view showing the assembled condition, a wire pressing convex portion 19 of a convex cross-section is formed on an inner surface of a body 17 of the wire holding cover 16, and a wire holding recess portion 17a of a corrugated shape is formed continuously on the surface of the wire pressing convex portion 19 over an entire length thereof, as shown in FIG. 2. Opposite end portions of the elongate cover body 17 are turned substantially at right angles, and fitting recesses 18 are formed through these opposite end portions, respectively. The fitting recesses 18, formed respectively in these opposite end portions, can be fitted respectively on the fitting projections 15, formed respectively at the opposite ends of the housing of the terminal block 11, substantially in a one-touch action with a click feeling through an undercut fitting operation utilizing elastic deformation of the resin.

A flat cable 20 is electrically connected to the male connector 10 of the above construction intermediate opposite ends thereof. The flat cable 20 comprises a plurality of juxtaposed electric wires 21 joined together into an integral, flattened form, for example, by fusing an insulating sheath.

Next, the assembling operation of the flat cable-connecting connector of this embodiment, having the above construction, as well as the operation thereof in use, will be described mainly with reference to FIG. 3 and also to FIGS. 1 and 2.

The connecting portion (target portion) of the flat cable 20 intermediate the opposite ends thereof is laid over the upper surface of the terminal block 11 of the male connector 10 in intersecting relation thereto.

Then, the wire holding cover 16 is put on the connecting portion of the flat cable 20, intersecting the terminal block, in covering relation thereto, and is pressed to urge this connecting portion from the upper side. Namely, the flat cable 20 is pressed by the wire holding cover 16 from the upper side, so that the fitting recesses 18, formed respectively in the opposite end portions of the wire holding cover 16, are connected respectively to the fitting projections 15, formed respectively on the opposite ends of the terminal block 11, substantially in a one-touch action by undercut fitting. At this time, the press-connecting blades 13a of the male terminals 13, held in the terminal block 11, are caused to pierce respectively into the electric wires 21 at the connecting portion of the flat cable 20 from the lower side by the pressing force applied by the wire holding cover 16. As a result, the insulating sheath of each electric wire 21 is cut, and the press-connecting blade 13a of the male terminal 13 comes into contact with a conductor within the electric wire, and therefore is electrically connected thereto.

FIG. 3 is a transverse cross-sectional view showing a condition in which each electric wire 21 is thus electrically press-connected to the press-connecting blade 13a of the male terminal 13. As shown in this Figure, those portions 21a of the electric wires 21, disposed at the connecting portion of the cable, are pressed by the wire pressing convex portion 19, formed on the inner surface of the wire holding cover 16, from the upper side, and therefore are pressed against the upper surface of the terminal block 11. Those portions 21b and 21c of each electric wire 21, disposed respectively at the front and rear sides of the thus pressed electric wire portion 21a, are raised respectively by the pair of parallel wire holding ribs 14a and 14b, formed respectively at the front and rear sides of the terminal block 11, so that these portions 21b and 21c are bent generally at right angles, and ride on the wire holding ribs 14a and 14b, respectively, and these electric wire portions, thus riding respectively on the ribs 14a and 14b, are pressed against the inner surface of the wire holding cover 16.

Namely, the flat cable 20, adapted to intersect the male connector 10, is introduced into the male connector 10 from one side thereof, and is led out of this male connector from the other side thereof, and that portion of the flat cable 20, intersecting the male connector, is bent into a generally U-shape, and the electric wire portion 21a, defining the bottom portion of this bent portion, is press-connected to the male terminal 13. And besides, the electric wire portions 21b and 21c, disposed respectively at the front and rear sides of the electric wire portion 21a at the connecting portion, are held and clamped by the wire holding ribs 14a and 14b, respectively. As a result, even when a tension due to a pulling force or the like is applied to the flat cable 20 in either direction along the length thereof, this tension hardly acts on the electric wire portion 21a at the connecting portion, and the electric wire portions 21b and 21c, disposed respectively at the front and rear sides of the bent electric wire portion at the connecting portion, bear the burden of this tension.

As is clear from the foregoing, it is only necessary that the intermediate portion (target portion) of the flat cable 20 be pressed from the upper side into a generally U-shape by the wire holding cover 16, and be held between this wire holding cover and the terminal block 11, and any complicated structure is not required, and therefore the cost is low, and besides the cable connecting operation can be effected easily. At this time, a tension and a stress are not applied to the electric wire portions 21a, press-connected respectively to the male terminals 13, thereby effectively preventing the displacement of the connected portion of each electric wire and the disengagement of this connected portion from the male terminal, thus preventing the cutting of the electric wire.

Then, when the female connector (not shown) is fitted relative to the male connector 10, thus holding the flat cable 20 in connected relation thereto, and is joined thereto in an integrated manner, there is obtained the press-connecting connector in which the three elements (electric wire/female terminal/male terminal) are electrically connected together.

In this embodiment, the intermediate portion of the flat cable 20 is connected to the male connector 10. However, the present invention is not limited to such example, and the terminal block 11 and the wire holding cover 16, jointly forming the male connector 10, can be used without any change when one of the opposite end portions of the flat cable 20 is to be connected to the connector in a retained manner.

In this embodiment, the pair of parallel wire holding ribs 14a and 14b are formed on the upper surface of the terminal block 11 in such a manner that the rows of the male terminals 13 are disposed between the two ribs 14a and 14b. However, even in the case where only one of the wire holding ribs 14a and 14b is provided, this structure is effective for connecting one end portion of the flat cable 20 in a retained manner.

As described above, the intermediate portion (target portion) of the flat cable is pressed by the wire holding cover from the upper side, and is pressed into the space between the wire holding ribs on the terminal block, so that this intermediate portion of the cable is held between the wire holding cover and the terminal block. That portion of each electric wire of the thus pressed flat cable, defining a bottom portion of the bent portion thereof, is electrically press-connected to the press-connecting blade of the male terminal. Those portions of the electric wire, disposed respectively at the front and rear side of this electrically-connected portion of the electric wire, ride on the wire holding ribs, respectively. These portions of the electric wire, riding respectively on the wire holding ribs, are pressed and held by the wire holding cover. Therefore, even when a tension or a stress due to a pulling force is applied to the flat cable, the ridden portions of the electric wire bear the burden of this tension, and therefore the tension will not act on the electrically-connected portion of the electric wire, press-connected to the press-connecting blade of the male terminal, thus protecting this connected portion.

In the flat cable-connecting connector of the present invention, the pair of parallel, elongate wire holding ribs are provided respectively at the front and rear sides of the press-connecting blades of the male terminals held in the terminal block, and those portions of each electric wire, disposed respectively at the front and rear sides of the electrically-connected portion of the electric wire of the flat cable, ride on the two wire holding ribs, respectively. Therefore, even when a tension is applied to the flat cable in either direction along the length thereof, the ridden portions of the electric wire bear the burden of the tension, thereby effectively protecting the electrically-connected portion of the electric wire press-connected to the press-connecting blade.

In the flat cable-connecting connector of the present invention, the groove portion of a recessed cross-section is formed between the pair of parallel wire holding ribs, and the convex portion is formed on the inner surface of the wire holding cover, and the convex portion is engaged in the recessed groove portion, so that the flat cable is held and clamped in such a manner that the flat cable is bent into a generally U-shape or a flanged cap-shape over the area of engagement therebetween, and the tension hardly acts on the electrically-connected portion of the electric wire press-connected to the press-connecting blade of the male terminal, and therefore the electrically-connected portion of the electric wire will not be displaced from the male terminal, and will not be disengaged therefrom, thus preventing the cutting of the electric wire.

What is claimed is:

1. A flat cable-connecting connector, comprising:
a terminal block to which a plurality of male terminals having press-connecting blades are attachable;
a plurality of wire holding ribs formed on the terminal block in a projected manner, the wire holding ribs being respectively located at front and rear sides of the press-connecting blades of the male terminals held by the terminal block; and
a wire holding cover attachable to the terminal block in order to hold a flat cable including a plurality of electric wires between the wire holding cover and the terminal block,
wherein when the wire holding cover is attached to the terminal block, the flat cable is bent between the wire holding ribs, so that the flat cable is press-connected, at a predetermined portion of the flat cable in a direction of a length thereof, to the press-connecting blades of the male terminals held by the terminal block.

2. The flat cable-connecting connector of claim 1, wherein a pair of the wire holding ribs are located at the front and rear sides of the press-connecting blades of the male terminals, and are disposed in parallel relation to each other, and wherein when the wire holding cover is attached to the terminal block, first portions of the flat cable respectively located at front and rear sides of a second portion thereof, that is press-connected to the press-connecting blades, ride respectively on the pair of wire holding ribs, so that the first portions are pressed and held by the wire holding cover.

3. The flat cable-connecting connector of claim 2, wherein a groove portion of a recessed cross-section is formed between the pair of parallel wire holding ribs, and a convex portion is formed on an inner surface of the wire holding cover, and where in the convex portion is engaged in the groove portion to press-hold the flat cable.
